(19) United States
(12) Patent Application Publication
(10) Pub. No.: US 2007/0044295 A1
(43) Pub. Date: Mar. 1, 2007

(54) Use of nanoparticles in film formation and as solder

(75) Inventor: Jian Chen, Mountain View, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Nanosys, Inc., Palo Alto, CA (US)

(21) Appl. No.: 11/432,553

(22) Filed: May 12, 2006

Related U.S. Application Data
(60) Provisional application No. 60/679,990, filed on May 12, 2005.
(60) Provisional application No. 60/730,886, filed on Oct. 28, 2005.
(60) Provisional application No. 60/735,157, filed on Nov. 10, 2005.

(51) Int. Cl. H01S 4/00

(52) U.S. Cl. 29/592.1; 420/591

(57) ABSTRACT

Nanoparticle compositions for use as solder, and methods for joining two or more material surfaces using nanoparticle solder compositions are described. Due to their small size, nanoparticles of a particular material have a lower melting temperature than the same material in bulk, thereby providing a homogenous bond between two or more materials when the nanoparticle solder is solidified. A gas species, such as hydrogen, can be introduced to further lower the melting temperature of the nanoparticles. The nanoparticles can also be used to form films on low melting point, substrates, including flexible substrates. The nanoparticles for use in the present invention can comprise any material, including semiconductor materials, metals, or insulator materials, and are less than about 20 nm in diameter, although larger sizes can also be used.

### CROSS REFERENCE TO RELATED APPLICATIONS

The present application claims the benefit of the filing dates of U.S. Provisional Patent Application No. 60/679,990, filed May 12, 2005, U.S. Provisional Patent Application No. 60/730,886, filed Oct. 28, 2005 and U.S. Provisional Patent Application No. 60/735,157, filed Nov. 10, 2005, the disclosures of each of which are incorporated herein by reference in their entireties.

### BACKGROUND OF THE INVENTION

1. Field of the Invention

The present invention relates to nanoparticle compositions for use in soldering applications and methods of soldering using nanoparticles. The present invention also relates to films formed from nanoparticles.

2. Background Art

Nanoparticles and nanocrystals have gained a great deal of attention for their interesting and novel properties in electrical, chemical, optical and other applications. Such nanomaterials have a wide variety of expected and actual applications, including use as semiconductors for nanoscale electronics, optoelectronic applications in emissive devices, such as nanolasers and LEDs, in photovoltaic applications, and sensor applications, e.g., as nanoChemFETS.

The thermal properties of nanoparticles of many materials, including some semiconductor materials, have been studied by several groups. A report by Goldstein et al. indicates that the reduction in melting temperature of CdS nanoparticles follows a 1/diameter relationship as the nanoparticles are reduced in size. Goldstein, A. N. et al., “Melting in Semiconductor Nanocrystals,” Science 256:1425-1427 (1992). Similar phenomena have been noted in traditional metals, such as gold nanoparticles. See Buffat, P and Borel, J-P., “Size Effect on the Melting Temperature of Gold Particles,” Physical Review A 13:2287-2298 (1976). The melting temperature of palladium clusters has also been observed to decrease in the presence of hydrogen gas. See Grönbeck, H. et al., “Hydrogen Induced Melting of Palladium Clusters,” Z. Phs. D. 40:469-471 (1997) and Grönbeck, H. et al., “Does Hydrogen Pre-melt Palladium Clusters?,” Chem. Phs. Letters 264:39-43 (1997).

Traditional soldering techniques utilize a mixture of lead and tin or other metallic mixtures to join and provide an electrical path between contacts, such as wires or various circuit components. Traditional methods, however, generate a bond between the contact surfaces that is composed of a material that is different than either of the contact components. This in turn can cause deficient material, electrical, thermal, chemical and optical properties at the bond. There therefore exists a need for a solder composition, and soldering methods, which allow bonding between two contacts (e.g., electrical contacts) such that the bond between the materials does not negatively impact the material, electrical, thermal, chemical or optical properties of the joined materials.

In addition, as the melting temperature of certain polymeric (and other material) substrates is below that of many materials used in the construction of displays, radiofrequency identifiers and transistor backplanes, this limits the types of films that can be prepared on such substrates. Thus, a need exists for processes for preparing films on such flexible, low melting point substrates.

### BRIEF SUMMARY OF THE INVENTION

The present invention fulfills needs present in the art by providing nanoparticles for use as solder and methods of joining materials using the nanoparticle compositions. By using nanoparticles of selected sizes, alone or in the presence of additional gas species, a homogenous bond can be created between two materials, such that the various properties of the material are maintained at the bond site. The decreased melting temperature of the nanoparticles allow the nanoparticles to melt and form a bond while maintaining the structure of the bulk material being joined.

In an embodiment, the present invention provides solder compositions for joining a surface of a first material and a surface of a second material, comprising one or more nanoparticles, wherein the nanoparticles have a melting temperature less than the melting temperature of the first and second materials. In embodiments, the nanoparticles further comprise one or more ligands attached to an outer surface thereof. The nanoparticles can comprise any suitable material.

Nanoparticles for use in the practice of the present invention can comprise material that is the same as the first and second materials, or can comprise material that is different than the first and/or second materials. The nanoparticles will generally be less than about 20 nm in diameter. In other embodiments, the solder composition can comprise a diverse population of nanoparticles that range from between about 1 nm to about 10 nm in diameter, or more suitably about 1 nm to about 5 nm in diameter.

The present invention also provides methods for joining a surface of a first material and a surface of a second material, comprising: (a) providing a surface of a first material and a surface of a second material to be joined, (b) layering a solder composition comprising nanoparticles on the surface of the first and/or second materials, (c) contacting the surface of the first material with the surface of the second material; (d) heating the solder composition to a temperature where the solder composition melts, and (e) solidifying the solder composition, whereby the surfaces of the first and second materials are joined by the solidified solder composition. In an embodiment, the methods of the present invention generate a homogenous material. Nanoparticle compositions and sizes useful in the methods of the present invention are described throughout. In an embodiment, the nanoparticles will comprise a ligand attached to their surface. In other embodiments, the heating in step (c) does not melt the first or second materials. In other embodiments a first gas species, such as hydrogen, can be provided during heating step (c) so as to further lower the melting temperature of the nanoparticles.

The present invention also provides methods for preparing a surface of a first material for soldering, comprising: layering nanoparticles of a second material on the surface, the nanoparticles having one or more ligands attached to an outer surface thereof, wherein the nanoparticles substantially cover the surface. The nanoparticles can comprise the same material, or can comprise a different material, as the surface being prepared. Suitable materials and sizes for the nanoparticles are described throughout the present disclosure.

The present invention also provides a nanoparticle solder prepared by a process comprising: (a) providing nanoparticles, (b) layering the nanoparticles on a surface of a first material, and (c) heating the nanoparticles to a temperature where the nanoparticles melt, but the first material does not melt. The nanoparticles can comprise a ligand attached to their surface, and can be prepared from any of the materials, and in the various size ranges, disclosed throughout the present disclosure. In certain embodiments, a first gas species, such as hydrogen, can be provided during heating step (c). This gas species further lowers the melting temperature of the nanoparticles.

The present invention is also directed to processes for preparing a film on a substrate, comprising: (a) positioning nanoparticles on a surface of a substrate; and (b) heating at least the nanoparticles to a temperature where the nanoparticles melt and form the film on the substrate. The nanoparticles can comprise a ligand attached to their surface, and can be prepared from any of the materials, and in the various size ranges, disclosed throughout. The present invention also provides films prepared by the processes disclosed throughout this description. In certain embodiments, the films are formed on low melting point, flexible substrates, such as polymers for use in applications such as displays, radiofrequency identifier tags, transistor backplanes and the like apparatus.

Additional features and advantages of the invention will be set forth in the description that follows, and in part will be apparent from the description, or may be learned by practice of the invention. The advantages of the invention will be realized and attained by the structure and particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIGS. 1A and 1B show nanoparticles used as solder to join two material surfaces.

FIG. 1C shows a nanoparticle with a surface ligand in accordance with an embodiment of the present invention.

FIG. 2 shows a flow chart representing a method for joining two material surfaces with nanoparticles in accordance with an embodiment of the present invention.

FIG. 3 shows a flow chart representing a process for preparing nanoparticle solder in accordance with an embodiment of the present invention.

FIG. 4A shows a substrate layered with nanoparticles in accordance with one embodiment of the present invention.

FIG. 4B shows a film formed on a substrate in accordance with one embodiment of the present invention.

FIG. 5 shows a flowchart representing a process for preparing films on substrates using nanoparticles in accordance with one embodiment of the present invention.

The present invention will now be described with reference to the accompanying drawings. In the drawings, like reference numbers indicate identical or functionally similar elements.

### DETAILED DESCRIPTION OF THE INVENTION

It should be appreciated that the particular implementations shown and described herein are examples of the invention and are not intended to otherwise limit the scope of the present invention in any way. Indeed, for the sake of brevity, conventional electronics, manufacturing, semiconductor devices, and nanocrystal, nanoparticle, nanowire (NW), nanorod, nanotube, and nanoribbon technologies and other functional aspects of the systems (and components of the individual operating components of the systems) may not be described in detail herein. Further, the techniques are suitable for applications in electrical systems, optical systems, consumer electronics, industrial or military electronics, wireless systems, space applications, or any other application.

As used herein, the terms “nanoparticle” and “nanocrystal” are used interchangeably. A nanoparticle has at least one region or characteristic dimension with a dimension of less than about 500 nm, including on the order of less than about 1 nm. As used herein, when referring to any numerical value, “about” means a value of ±10% of the stated value (e.g. “about 100 nm” encompasses a range of sizes from 90 nm to 110 nm, inclusive). The present invention also encompasses the use of polycrystalline or amorphous nanoparticles. The terms “nanoparticle solder” and “nanoparticle solder composition” are used herein to refer to nanoparticles that are useful in the practice of the present invention for joining two or more material surfaces using the methods and processes set forth herein.

Typically, the region of characteristic dimension is along the smallest axis of the structure. Nanoparticles for use in the present invention are suitably substantially the same size in all dimensions, e.g., substantially spherical, though non-spherical nanoparticles can also be used. Nanoparticles can be substantially homogenous in material properties, or in certain embodiments, can be heterogeneous. The optical properties of nanoparticles can be determined by their particle size, chemical or surface composition. The ability to tailor nanoparticle size in the range between about 1 nm and about 20 nm allows for very good control over the melting temperature of the nanoparticles, although the present invention is applicable to other size ranges of nanoparticles. The term “nanoparticles” as used herein also encompasses nanowires, nanorods, nanoribbons, and other similar elongated structures known to those skilled in the art. As described throughout, nanowires (or similar structures) for use in the present invention will suitably have at least one characteristic dimension less than about 500 nm. Suitably, nanowires for use in the present invention will be less than about 500 nm, less than about 300 nm, less than about 200 nm, less than about 100 nm in diameter, less than about 50 nm in diameter or less than about 20 nm in diameter (i.e. the dimension across the width of the nanowire). Examples of such nanowires include semiconductor nanowires as described in Published International Patent Application Nos. WO 02/17362, WO 02/48701, and WO 01/03208, carbon nanotubes, and other elongated conductive or semiconductive structures of like dimensions.

Nanoparticles for use in the present invention can be produced using any method known to those skilled in the art. Suitable methods are disclosed in U.S. patent application Ser. No. 11/034,216, filed Jan. 13, 2005, U.S. patent application Ser. No. 10/796,832, filed Mar. 10, 2004, U.S. patent application Ser. No. 10/656,910, filed Sep. 4, 2003 and U.S. Provisional Patent Application No. 60/578,236, filed Jun. 8, 2004, the disclosures of each of which are incorporated by reference herein in their entireties. The nanoparticles for use in the present invention can be produced from any suitable material, including an inorganic material, such as inorganic conductive materials (e.g., metals), semiconductive materials and insulator materials. Suitable semiconductor materials include those disclosed in U.S. patent application Ser. No. 10/796,832 and include any type of semiconductor, including group II-VI, group III-V, group IV-VI and group IV semiconductors. Suitable semiconductor materials include, but are not limited to, Si, Ge, Sn, Se, Te, B, C (including diamond), P, BN, BP, BAs, AlN, AlP, AlAs, AlSb, GaN, GaP, GaAs, GaSb, InN, InP, InAs, InSb, AlN, AlP, AlAs, AlSb, GaN, GaP, GaAs, GaSb, ZnO, ZnS, ZnSe, ZnTe, CdS, CdSe, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, (Al, Ga, In)₂ (S, Se, Te)₃, Al₂CO, and an appropriate combination of two or more such semiconductors. Suitable metals include, but are not limited to, Au, Ag, Fe, Co, Ni and Al. Suitable insulator materials include, but are not limited to, SiO₂, TiO₂ and Si₃N₄.

The nanoparticles useful in the present invention can also further comprise ligands conjugated, associated or otherwise attached to their surface as described throughout. Suitable ligands include any group known to those skilled in the art, including those disclosed in (and methods of attachment disclosed in) U.S. patent application Ser. No. 10/656,910, U.S. patent application Ser. No. 11/034,216, and U.S. Provisional Patent Application No. 60/578,236, the disclosures of each of which are hereby incorporated by reference herein for all purposes. Use of such ligands can enhance the ability of the nanoparticles to associate and spread on the various material surfaces that are going to be joined together, or on which a film is to be formed, such that the material surface is substantially covered by nanoparticles. In addition, such ligands act to keep the individual nanoparticles separate from each other so that they do not aggregate together prior to or during application.

In an embodiment, the present invention provides a solder composition for joining a surface of a first material and a surface of a second material, comprising one or more nanoparticles, wherein the nanoparticles have a melting temperature less than the melting temperature of the first and second materials.

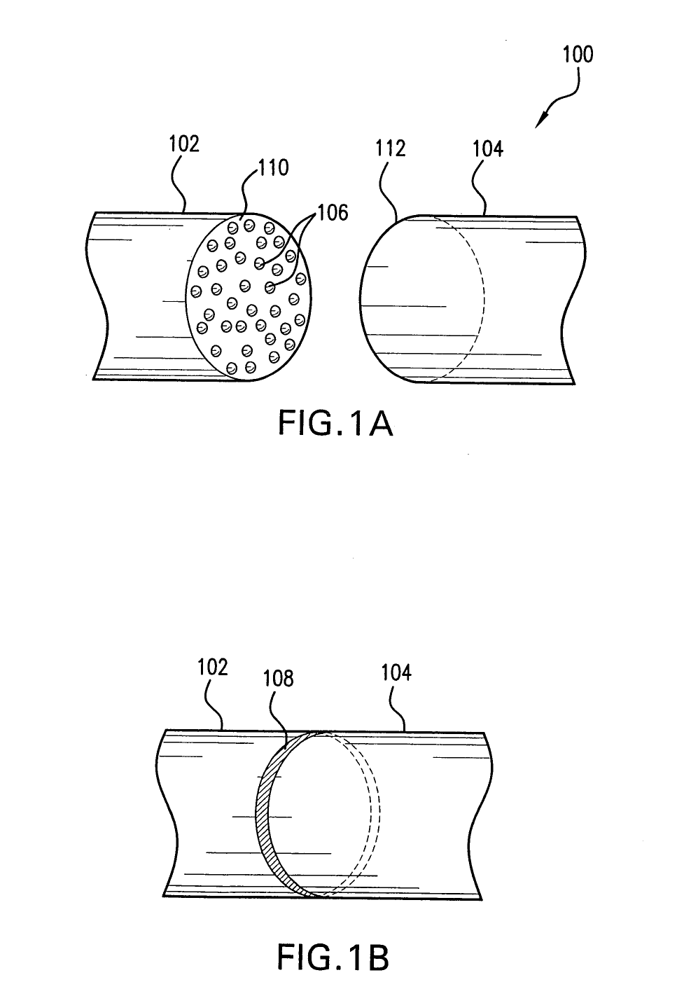

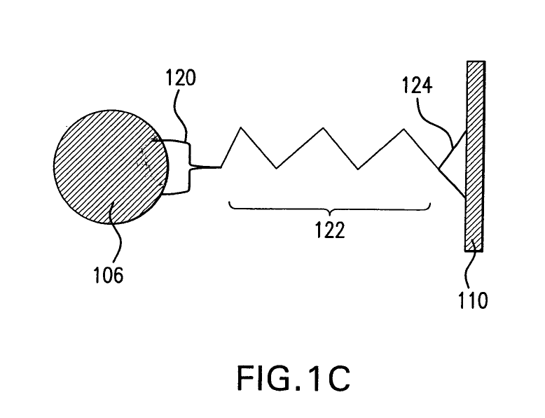

FIGS. 1A and 1B show views of a generic process of the present invention for using nanoparticles as solder to join two materials. As shown in FIG. 1A, nanoparticles 106 are layered on a surface 110 of a first material 102 to be joined with a second material 104. In embodiments, nanoparticles 106 can be layered on the surfaces 110/112 of both the first 102 and second 104 materials to be joined, or can be layered on only one of the two material surfaces. As shown in FIG. 1A, nanoparticles 106 are layered on surface 110 and surface 112 (not visible in FIG. 1A) which represent ends of cylindrical objects, such as wires. In alternative embodiments, first and second materials 102 and 104 can have other shapes and configurations, and surfaces 110 and 112 can be at any location on first and second materials 102 and 104. The term “layered” as used herein is meant to encompass any of the terms known in the art such as formed, attached, associated, generated, deposited, grown, bonded etc., which indicate that the nanoparticles of the present invention are physically associated with the surface(s) of the material or materials to be joined.

After nanoparticles 106 are layered on the surface(s), nanoparticles 106 are heated to a temperature such that they melt. The two material surfaces, 110 and 112, are then brought into contact with one another, which allows the two surfaces, 110 and 112, to be joined when nanoparticles 106 are cooled and solidified, such as is shown in FIG. 1B. In embodiments, nanoparticles 106 are heated prior to bringing the two surfaces (110, 112) into contact with one another. In other embodiments, the two surfaces (110, 112) are brought in contact with one another first, such that nanoparticles 106 are in contact with both surfaces, and then nanoparticles 106 are heated to a temperature where they melt. As such, heating and contacting the surfaces to be joined can occur in any order in accordance with embodiments of the present invention. Heating nanoparticles 106 so that they melt generates a liquid phase material(s) that is able to flow and fill the gap between the two material surfaces 110 and 112. As shown in FIG. 1B, upon cooling, a solidified solder 108 is produced that bonds the two materials 102 and 104 and material surfaces 110 and 112. As used herein, the terms “solder” and “solder compositions” are meant to indicate a material(s) that is used to bond material surfaces. The term is not limited to metallic-based “solder,” but includes any of the materials disclosed herein or known in the art. As used herein the term “bond” is used to mean that material surfaces are attached to one another in such a way that the contacting surfaces do not come apart under conditions routinely found in their use, manufacture, wear, or modification. While the bond created between the surfaces may not be a permanent structure, the intent is to connect the surfaces in such a way that they can be used and act as a single piece of material. It should be understood that, while for simplicity, the methods, processes and compositions of the present invention are generally described as joining two material surfaces, any number of materials and material surfaces (e.g., 2, 3, 5, 10, 20, etc.) can be joined together, and the present invention is not limited to only joining two material surfaces together.

As discussed throughout, nanoparticles useful in the practice of the present invention will melt at a temperature below the melting temperature of a bulk sample composed of the same material. In this way, the nanoparticles 106 of the present invention can be melted, and therefore used as a solder, at a temperature where a first material/surface 102/110 and second material/surface 104/112 composed of the same material will not melt. The melting temperature of the nanoparticles can be below the melting temperature of the material surfaces to be joined by any amount, so long as during heating, the materials/surfaces being joined do not significantly melt, i.e. begin to flow or deform to a significant degree that impedes joining. In certain embodiments, the melting temperature of the nanoparticles will be substantially below the melting temperature of the materials/surfaces being joined, for example, 10's to 100's of degrees Kelvin, to even 1000 degrees Kelvin, below the melting temperature of the materials/surfaces being joined.

Thus, the compositions and methods disclosed herein allow for soldering at very low temperatures. This allows for the generation of homogenous materials, as discussed throughout, as the materials/surfaces being joined can be bound with material of the same composition, without concern of melting the bulk surfaces/materials being joined. In addition, the compositions and methods disclosed herein are also useful when the surfaces and materials that are being joined comprise additional characteristics or functionality that preclude soldering at elevated temperatures. For example, the materials/surfaces being joined may comprise electrical, optical, biological or other components that cannot withstand elevated temperatures. Therefore, by utilizing the compositions and methods disclosed herein, the materials/surfaces can be joined by soldering at substantially reduced temperatures, thereby reducing or eliminating concerns of harming or modifying the material/surfaces being joined and/or any additional components or functionalities associated with those materials/surfaces.

Nanoparticles for use in the practice of the present invention can be produced from any suitable material. In certain embodiments, the nanoparticles can comprise semiconductor materials. In other embodiments, the nanoparticles can comprise metals or metal alloys. In still further embodiments, the nanoparticles can comprise insulating materials.

In embodiments where the nanoparticles comprise semiconductor material, any of the semiconductors described throughout can be used. In certain such embodiments, useful semiconductors include, but are not limited to, semiconductor materials of group IV, group III-V, and group II-VI semiconductors, such as Si, ZnS and CdS. Other semiconductors known in the art can also be used in the practice of the present invention.

In embodiments where the nanoparticles comprise metals, or metal alloys, useful metals include, but are not limited to, alkali metals, transition metals, noble metals and rare-earth metals, including their alloys. Exemplary metals include Au, Ag, Fe, Co, Ni and Al. Other metals known in the art can also be used in the practice of the present invention.

In embodiments where the nanoparticles comprise insulting materials, useful insulating materials include, but are not limited to, SiO₂, TiO₂ and Si₃N₄. Other insulating materials known in the art can also be used in the practice of the present invention.

In certain embodiments of the present invention, the first and second materials, 102 and 104, are composed of the same material, and the nanoparticles 106 used as solder to join the two materials are also composed of this same material. In such embodiments, the use of nanoparticles composed of the same material as the two (or more) materials that are being joined results in a homogeneous material after the nanoparticle solder has solidified to join the surfaces as shown in FIG. 1B. This provides clear advantages over traditional soldering techniques where the solder is composed of materials that are different from the materials being joined. In the present invention, after the nanoparticle solder is solidified, a material results that has the same, or substantially the same, properties as the two bulk surfaces/materials that were joined, including material, chemical, electrical, physical and optical properties.

The use of nanoparticles as solder, where the nanoparticles comprise the same material as one or both of the materials being joined, is made possible by the present invention. As the nanoparticles melt at a lower temperature than the “bulk” surfaces/materials being joined, there is no concern that the surfaces being joined will also melt. As discussed above, the depression in melting temperature of nanoparticles of a certain material exhibits a 1/Diameter relationship, such that the melting temperature relative to a bulk material drops fairly rapidly as nanoparticle size is reduced below about 20 nm. See e.g., Goldstein, A. N. et al., Science 256:1425-1427 (1992) and Buffat, P and Borel, J-P., Physical Review A 13:2287-2298 (1976), the disclosures of which are incorporated by reference herein in their entireties.

While certain embodiments of the present invention utilize nanoparticles composed of material that is the same as the two (or more) materials/surfaces being joined, it is also within the scope of the invention to utilize nanoparticles composed of materials that are different from either one or all of the materials/surfaces being joined. For example, materials/surfaces composed of the same material can be joined with nanoparticles of a different material, or materials/surfaces composed of different materials can be joined using nanoparticles composed of a material that is the same (or substantially the same) as one of the materials/surfaces being joined.

When joining material surfaces using the compositions and methods of the present invention, the nanoparticles can be heated using any method known in the art that will cause the nanoparticles to melt such that they flow and bond to the material surfaces being joined. Suitable methods of heating useful in the practice of the present invention include, but are not limited to, use of a soldering iron or similar device to directly heat the nanoparticles, or to heat one or more of the materials/surfaces being joined, which in turn heats the nanoparticles via conduction; use of an oven or similar device such that the nanoparticles and the materials being joined are heated by an overall increase in temperature of the surrounding environment; use of a laser or similar energy source to increase the temperature of the nanoparticles and/or the materials being joined.

Nanoparticles for use in the present invention can be less than about 20 nm in diameter, including less than about 10 nm in diameter and even less than about 5 nm in diameter. The most dramatic depression in the melting temperature of the nanoparticles when compared with bulk material generally occurs in nanoparticles less than about 20 nm in diameter. In other embodiments, the nanoparticles for use in the practice of the present invention can comprise a diverse population of nanoparticles that range from between about 1 nm to about 10 nm in diameter, including, between about 1 nm to about 5 nm in diameter. Use of a population of nanoparticles in which the sizes of the nanoparticles vary, and are selectively prepared so as to cover a range of sizes, allows for a tailoring of the melting temperature of the nanoparticle solder. The percentage of nanoparticles of a particular size can be modified relative to others in the population so as to regulate the melting temperature of the entire population.

In suitable embodiments of the present invention, the nanoparticles will further comprise one or more ligands attached to an outer surface of the nanoparticles. It is desirable that the nanoparticles do not aggregate. That is, that they remain separate from each other and do not coalesce with one another to form larger aggregates prior to and during layering on the material surface(s) to be joined. This is important so as to aid spreading and layering of the nanoparticles. Ligands attached to an outer surface of the nanoparticles provide contact or association points between the nanoparticles and the material surface(s) such that layering of the nanoparticles on a material surface(s) (e.g., surface 110 in FIG. 1A) results in a surface that is substantially covered by the nanoparticles, prior to joining with another material surface(s).

Ligands useful in the practice of the present invention for association and attachment to the nanoparticle solder compositions of the present invention are described in U.S. patent application Ser. No. 11/034,216, incorporated by reference herein for all purposes. Example ligands for use in the practice of the present invention include a novel 3-part ligand, in which a head-group, tail-group and middle/body-group can each be independently fabricated and optimized for their particular function, and then combined into an ideally functioning complete surface ligand. In other embodiments, a middle/body group is not required, and the ligands can comprise simply a head-group and a tail-group.

FIG. 1C shows a representation of a surface ligand in accordance with an embodiment of the present invention. As shown in FIG. 1C, a ligand comprises head-group 120, a middle/body-group 122 and a tail-group 124. The head-group 120 is generally selected to bind specifically to the material of the nanoparticle 106 (e.g., can be tailored and optimized for Ag, CdS, ZnS or any other nanoparticle material). The tail-group 124 can be designed to interact strongly with the material surface 110 to be covered with the nanoparticle solder, such that layering and spreading of the nanoparticles 106 on the material surface 110 is optimized and a substantial portion of surface 110 is covered by nanoparticles 106. In other embodiments, tail-group 124 can be tailored to increase the solubility of nanoparticles 106 in suitable solvents. In other embodiments, tail-group 124 can be tailored to increase the solubility of nanoparticles 106 in suitable solvents, as well as, to allow nanoparticles 106 to interact with the material surface 110 to aid in spreading. A middle or body-group 122 is often selected for specific electronic functionality (e.g., charge isolation). However, in certain embodiments, middle or body-group 122 is not required and can be eliminated, and thus a ligand comprising simply a head-group 120 and a tail-group 124 can be used. A tailored ligand can be optionally designed to bind strongly to the nanoparticle 106 and to allow for increased solubility and/or spreading/layering on the material surface 110.

In an example embodiment, the ligand molecule can be synthesized using a generalized technique allowing three separate groups to be synthesized separately and then combined, as disclosed in U.S. patent application Ser. No. 11/034,216. Head-groups 120 and tail-groups 124 can contain groups that match the nanoparticle 106 and the material surface 110 to be joined, e.g., silicon groups to match a silicon nanoparticle and a silicon surface. The middle/body 122 unit, if utilized, can be selected for charge insulation (e.g., large energy gap for both electrons and holes). The insulating group (middle/body unit 122), it utilized, can be selected from long-chain alkanes of various lengths and aromatic hydrocarbons.

In other embodiments, material surfaces 110 and 112 can be specially treated or prepared so as to aid in nanoparticle 106 spreading and attachment. For example, material surfaces 110 and 112 can be treated with sputter cleaning or a suitable surface coating. Useful cleaning and surface coating methods are known in the art and can be used in the practice of the present invention. For example, a self-assembled layer of molecules can be layered on surfaces 110 and/or 112 by vapor phase or liquid phase deposition to aid in spreading and attachment of nanoparticles 106. In certain embodiments, for example, nanoparticles 106 may spread more easily on non-polar surfaces and thus, surfaces 110 and/or 112 may be treated so as to generate a non-polar surface for attachment and/or convert these surfaces from polar to non-polar. In other embodiments, a polar surface can be generated if desired.

While the nanoparticle solder compositions of the present invention are useful for joining components of electronics (e.g., wires, nanowires, other electrical contacts), they can also be used to join bulk materials, e.g., metals, semiconductors, insulators, such as for use in semiconductor substrates, insulator joints and optical applications and pathways (e.g. fiber optics).

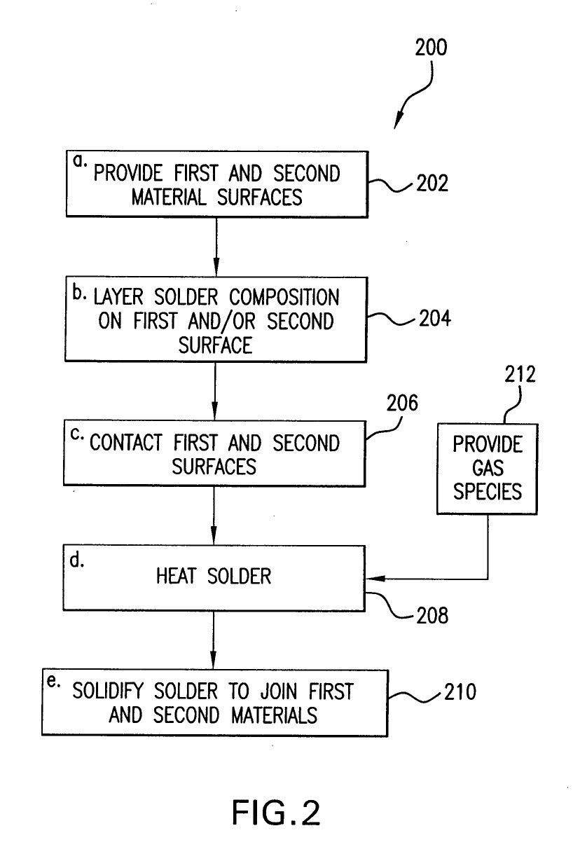

In another embodiment, as represented by flowchart 200 of FIG. 2, with reference to FIGS. 1A and 1B, the present invention provides a method for joining a surface 110 of a first material 102 and a surface 112 of a second material 104. In step 202 of FIG. 2, a surface 110 of a first material 102 and a surface 112 of a second material 104 to be joined are provided. In step 204 of FIG. 2, a solder composition comprising nanoparticles 106 is layered on the surface 110/112 of the first and/or second materials 102/104. In step 206 of FIG. 2, surface 110 of first material 102 is contacted with surface 112 of second material 104. In step 208 of FIG. 2 the solder composition is heated to a temperature where the solder composition melts. Steps 206 and 208 shown in flowchart 200 of FIG. 2 can occur in any order. In step 210 of FIG. 2, the solder composition is solidified, whereby the surfaces 110/112 of the first and second materials 102/104 are joined by the solidified solder composition 108.

As noted above, in embodiments, methods of the present invention generate a homogenous material when the nanoparticles that are used are composed of material that is the same as, or substantially the same as, the material of the two surfaces being joined. In other embodiments, the nanoparticles can comprise material that is different from either of the materials being joined. The nanoparticles for use in the methods of the present invention can comprise any material disclosed herein, such as the various semiconductors, metals and insulators. In an embodiment, the nanoparticles will comprise surface ligands to aid in attachment/spreading on the material surface(s) and can be in the size ranges discussed throughout. As discussed above, heating step 208 does not melt the materials being joined, but only the nanoparticles that form the solder composition.

In another embodiment, with reference to flowchart 200 in FIG. 2, the present invention provides methods for joining a surface of a first material and a surface of a second material as discussed above, further including step 212 in flowchart 200 of FIG. 2 of providing a gas species during heating step 208. By providing a gas species to the nanoparticle solder composition, the melting temperature of the nanoparticles can be reduced below the melting temperature of the bulk material and the melting temperature of nanoparticles of larger sizes. Therefore, by adjusting the pressure and/or amount of gas species present during the heating that occurs in step 208, the temperature required to melt the nanoparticles can be reduced even further, thereby reducing the concern of melting the material surfaces being joined. Any suitable gas species that lowers the melting temperature of the nanoparticles can be used, for example hydrogen gas.

In another embodiment, as represented in flowchart 200 of FIG. 2, with reference to FIGS. 1A and 1B, the present invention provides methods for preparing a surface 110 of a first material 102 for soldering. In step 204 of FIG. 2, nanoparticles 106 of a second material are layered on surface 110, the nanoparticles 106 having one or more ligands attached to an outer surface thereof, wherein the nanoparticles substantially cover surface 110. As discussed throughout, the nanoparticles 106 can comprise any material, including semiconductor, metal and insulator materials, and can comprise the same material as the first surface being prepared for soldering, though the nanoparticles can comprise a different material. The nanoparticles can be in the size ranges disclosed throughout. As discussed above, the presence of ligands on the surface of the nanoparticles, as shown in FIG. 1C, allows the nanoparticles to better associate, bind or attach to the material surface 110, and therefore spread over substantially the entire surface of the material being prepared for soldering. As used herein, the term “substantially cover” is used to indicate that the nanoparticles cover the majority of the surface of the material to be joined, such that when the nanoparticles melt, the surface is covered by the liquid phase material to such an extent that a bond can be created with another surface.

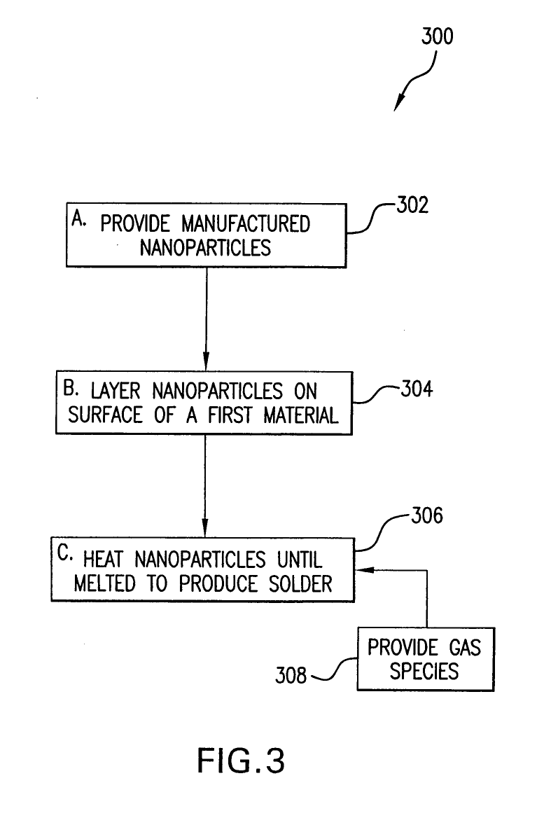

In another embodiment, as represented in flowchart 300 of FIG. 3, with reference to FIGS. 1A and 1B, a nanoparticle solder is prepared. In step 302 of FIG. 3, nanoparticles 106 are provided. In step 304 of FIG. 3, nanoparticles 106 are layered on a surface 110 of a first material 102. In step 306 of FIG. 3, the nanoparticles 106 are heated to a temperature where the nanoparticles melt, but the first material 102 does not melt. The nanoparticles for use in the processes to prepare nanoparticle solder of the present invention comprise size ranges and compositions as disclosed throughout, and in certain embodiments, can further comprise surface ligands attached to their outer surface. As shown in step 308 of flowchart 300 of FIG. 3, a gas species, such as hydrogen, can be added during heating step 306 so as to lower the melting temperature of the nanoparticles even further.

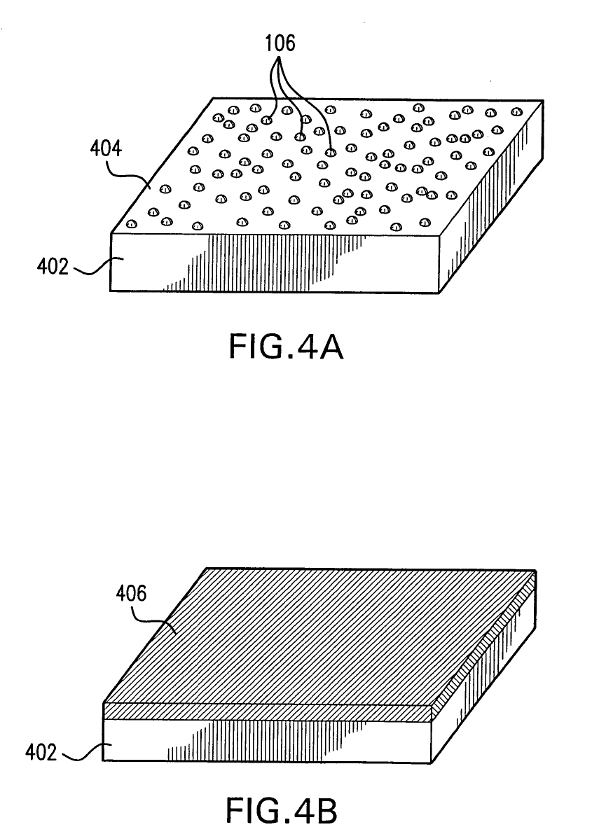

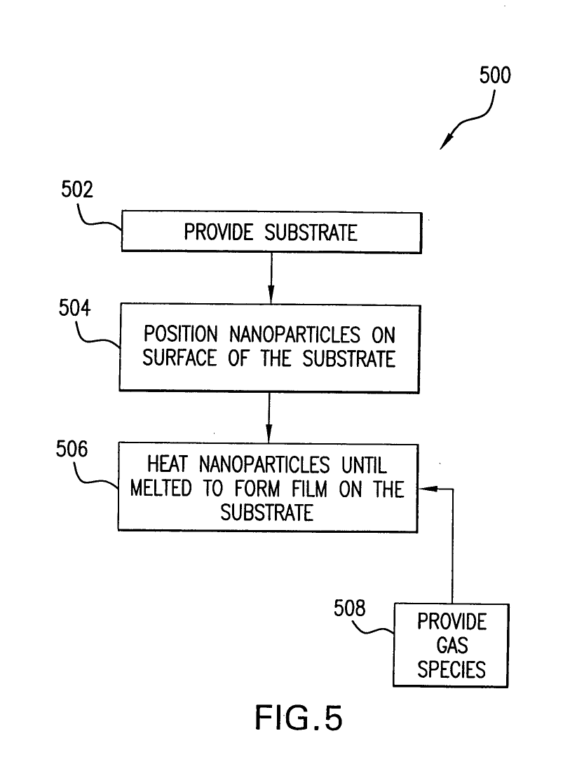

The present invention is also directed to processes for forming films on substrates, and films formed by such processes, using the nanoparticles disclosed throughout this description. As represented in a flowchart 500 of FIG. 5, with reference to FIGS. 4A and 4B, the present invention provides processes for preparing a film 406 on a substrate 402. In step 502 of FIG. 5, substrate 402 is provided or otherwise made available for processing. In step 504 of FIG. 5, nanoparticles 106 are positioned on a surface 404 of substrate 402. As used herein, the term “positioned” includes layering, or otherwise applying nanoparticles to the substrate, such as described throughout this description. In step 506 of FIG. 5, at least nanoparticles 106 (and generally substrate 402 as well) are heated to a temperature where the nanoparticles melt, such that the melted nanoparticles from the film 406 on substrate 402.

The nanoparticles for use in such film-forming processes comprise the size ranges and compositions as disclosed throughout this description, and in certain embodiments, can further comprise surface ligands attached to their outer surface. As shown in step 508 of flowchart 500 of FIG. 5, a gas species, such as hydrogen, can be added during heating step 506 so as to lower the melting temperature of the nanoparticles even further.

As the melting temperature of the nanoparticles is below that of the same material in bulk, films of such nanoparticles can be prepared on substrates with low melting temperatures (Tₘ). Thus, films can be formed on low melting point, flexible substrates, such as flexible polymers. As used herein, the phrase “low melting point,” as it refers to substrates disclosed throughout this description, indicates that the melting temperature of the substrate is equal to or greater than about 100° C. Exemplary low melting point substrates include, but are not limited to, poly(ethylene terephthalate) (PET), polimides (e.g., poly(phenylene polyimide)), poly(propylene), poly(dimethyl-siloxane), polyolefins, polyamides, and the like.

In addition to flexible, low melting point substrates, the films of the present invention can also be formed on material substrates with higher Tₘ, such as silicon, glass, quartz, and other polymerics and plastics such as polycarbonate, polystyrene, poly(etheretherketone) etc.

As noted throughout this description, the use of ligands can aid in the spreading of nanoparticles on the surface of the substrates. In film-forming applications, this provides better overall coverage of nanoparticles on the surface and limits aggregation prior to heating. When the nanoparticles are melted, the film formed thereby is substantially uniform in both thickness and coverage over the substrate. The term “substantially uniform,” as it relates to the thickness of the film, indicates that over the area of substrate initially covered by the nanoparticles, the thickness of the film varies by less than about 20%. The term “substantially uniform,” as it relates to the coverage of the film on the substrate, indicates that over the area of substrate initially covered by the nanoparticles, the film covers more than about 20% of the initial area.

The thickness of the films can be adjusted by controlling the amount of nanoparticles initially applied to the substrate. Film thicknesses can be in the range of few nanometers, to 10's or 100's of nanometers, up to several microns or even millimeters, depending on the amount of nanoparticles used. To generate thicker films, several film layers can be applied over the course of time. For example, an initial film can be prepared as described throughout and allowed to cool. A second layer of nanoparticles can be applied and then heated to generate a second film layer. As the melting temperature of the nanoparticles is less than that of the bulk film already present on the substrate, the initial film will not melt, but the nanoparticles will melt and flow over the first (or subsequent) film forming a second film layer, etc. This can be repeated as necessary until the desired thickness, e.g. nanometers to microns to millimeters, or even thicker films, is reached. The present invention also provides films on substrates prepared by such processes.

Example applications for the films of the present invention include driving circuitry for active matrix liquid crystal displays (LCDs) and other types of matrix displays, smart libraries, credit cards, radio-frequency identification (RFID) tags for smart price and inventory tags, security screening/surveillance or highway traffic monitoring systems, large area sensor arrays, and the like.

In RFID tag applications, a device known as a “tag” may be affixed to items or objects that are to be monitored. The presence of the tag, and therefore the presence of the item to which the tag is affixed, may be checked and monitored by devices known as “readers.” A reader may monitor the existence and/or location of the items having tags affixed thereto through wireless interrogations. Typically, each tag has a unique identifier (e.g., a number or some other electromagnetic characteristic associated with a number or the like) that the reader uses to identify the particular tag and item.

The films disclosed herein can be used in a variety of unique applications ranging from RF communications, to sensor arrays, to X-ray imagers, to flexible displays and electronics, and more. In addition, they can be used in lightweight, disposable or flexible displays with driver-electronics printed onto a single substrate, “penny”-RFID tags for universal RF-barcoding, integrated sensor networks for industrial monitoring and security applications, and phased-array antennas for wireless communications.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

What is claimed is:

1. A solder composition for joining a surface of a first material and a surface of a second material, comprising one or more nanoparticles, wherein said nanoparticles have a melting temperature less than the melting temperature of said first and second materials.

2. The solder composition of claim 1, wherein the nanoparticles further comprise one or more ligands attached to an outer surface thereof.

3. The solder composition of claim 1, wherein the nanoparticles comprise material selected from the group consisting of semiconductor material, metal and insulating material.

4. The solder composition of claim 3, wherein the semiconductor material is selected from the group consisting of group IV, group III-V, and group II-VI semiconductors.

5. The solder composition of claim 3, wherein the metal is selected from the group consisting of Au, Ag, Fe, Co, Ni and Al.

6. The solder composition of claim 3, wherein the insulating material is selected from the group consisting of SiO₂, TiO₂ and Si₃N₄.

7. The solder composition of claim 1, wherein the nanoparticles, the first material and the second material comprise the same material.

8. The solder composition of claim 1, wherein the nanoparticles comprise material that is different than the first material and the second material.

9. The solder composition of claim 1, wherein the nanoparticles, the first material and the second material each comprise different materials.

10. The solder composition of claim 1, wherein the nanoparticles are less than about 20 nm in diameter, less than about 10 nm in diameter or less than about 5 nm in diameter.

11. The solder composition of claim 1, wherein the composition comprises a diverse population of nanoparticles that range between about 1 nm to about 10 nm in diameter or between about 1 nm to about 5 nm in diameter.

12. A method for joining a surface of a first material and a surface of a second material, comprising:
(a) providing a surface of a first material and a surface of a second material to be joined;
(b) layering a solder composition comprising nanoparticles on the surface of the first and/or second materials;
(c) contacting the surface of the first material with the surface of the second material;
(d) heating the solder composition to a temperature where the solder composition melts; and
(e) solidifying the solder composition,
whereby the surfaces of the first and second materials are joined by the solidified solder composition.

13. The method of claim 12, wherein a homogenous material is generated.

14. The method of claim 12, wherein the layering comprises nanoparticles that further comprise a surface ligand attached an outer surface thereof.

15. The method of claim 12, wherein the layering comprises nanoparticles that comprise material selected from the group consisting of semiconductor material, metal and insulating material.

16. The method of claim 15, wherein the semiconductor material is selected from the group consisting of group IV, group III-V, and group II-VI semiconductors.

17. The method of claim 15, wherein the metal is selected from the group consisting of Au, Ag, Fe, Co, Ni and Al.

18. The method of claim 15, wherein the insulating material is selected from the group consisting of SiO₂, TiO₂ and Si₃N₄.

19. The method of claim 12, wherein the layering comprises nanoparticles that comprise material that is the same as the first and second materials.

20. The method of claim 12, wherein the layering comprises nanoparticles that comprise material that is different from the first and second materials.

21. The method of claim 12, wherein the layering comprises nanoparticles that are less than about 20 nm in diameter, less than about 10 nm in diameter or less than about 5 nm in diameter.

22. The method of claim 12, wherein the layering comprises nanoparticles that are a diverse population of nanoparticles that range between about 1 nm to about 10 nm in diameter or between about 1 nm to about 5 nm in diameter.

23. The method of claim 12, wherein the heating does not melt the first or second materials.

24. The method of claim 12, further comprising providing a first gas species during step (d).

25. The method of claim 24, wherein the gas species lowers the melting temperature of the nanoparticles.

26. The method of claim 25, wherein the gas species is hydrogen.

27. A method for preparing a surface of a first material for soldering, comprising: layering nanoparticles of a second material on the surface, the nanoparticles having one or more ligands attached to an outer surface thereof, wherein the nanoparticles substantially cover the surface.

28. The method of claim 27, wherein the first material and the second material are the same.

29. The method of claim 27, wherein the first material and the second material are different.

30. The method of claim 27, wherein the ligands bind to the surface of the first material.

31. The method of claim 27, wherein at least one of the first material and the second material comprise material selected from the group consisting of semiconductor material, metal and insulator material.

32. The method of claim 31, wherein the semiconductor material is selected from the group consisting of group IV, group III-V, and group II-VI semiconductors.

33. The method of claim 31, wherein the metal is selected from the group consisting of Au, Ag, Fe, Co, Ni and Al.

34. The method of claim 31, wherein the insulating material is selected from the group consisting of SiO₂, TiO₂ and Si₃N₄.

35. The method of claim 27, wherein the nanoparticles are less than about 20 nm in diameter, less than about 10 nm in diameter, or less than about 5 nm in diameter.

36. The method of claim 27, wherein the nanoparticles are a diverse population of nanoparticles that range between about 1 nm to about 10 nm in diameter or between about 1 nm to about 5 nm in diameter.

37. A nanoparticle solder prepared by a process comprising:
(a) providing nanoparticles;
(b) layering the nanoparticles on a surface of a first material; and
(c) heating the nanoparticles to a temperature where the nanoparticles melt, but the first material does not melt.

38. The nanoparticle solder of claim 37, wherein the nanoparticles further comprise a surface ligand attached to an outer surface thereof.

39. The nanoparticle solder of claim 37, wherein the nanoparticles comprise material selected from the group consisting of semiconductor material, metal and insulating material.

40. The nanoparticle solder of claim 39, wherein the semiconductor material is selected from the group consisting of group IV, group III-V, and group II-VI semiconductors.

41. The nanoparticle solder of claim 39, wherein the metal is selected from the group consisting of Au, Ag, Fe, Co, Ni and Al.

42. The nanoparticle solder of claim 39, wherein the insulating material is selected from the group consisting of SiO₂, TiO₂ and Si₃N₄.

43. The nanoparticle solder of claim 37, wherein the nanoparticles comprise a material that is the same as the first material.

44. The nanoparticle solder of claim 37, wherein the nanoparticles comprise a material that is different from the first material.

45. The nanoparticle solder of claim 37, wherein the nanoparticles are less than about 20 nm in diameter, less than about 10 nm in diameter, or less than about 5 nm in diameter.

46. The nanoparticle solder of claim 37, wherein the nanoparticles are a diverse population of nanoparticles that range between about 1 nm to about 10 nm in diameter, or between about 1 nm to about 5 nm in diameter.

47. The nanoparticle solder of claim 37, further comprising providing a first gas species during step (c).

48. The nanoparticle solder of claim 47, wherein the gas species lowers the melting temperature of the nanoparticles.

49. The nanoparticle solder of claim 48, wherein the gas species is hydrogen.

50. A process for preparing a film on a substrate, comprising:
(a) positioning nanoparticles on a surface of a substrate; and
(b) heating at least the nanoparticles to a temperature where the nanoparticles melt and form the film on the substrate,
wherein the nanoparticles comprise group IV semiconductor material or metal, and
wherein the nanoparticles comprise a surface ligand attached to an outer surface thereof.

51. The process of claim 50, wherein the positioning comprises positioning nanoparticles comprising group IV semiconductor material selected from the group consisting of Si, Ge, Sn, C and Zr.

52. The process of claim 50, wherein the positioning comprises positioning nanoparticles comprising metal selected from the group consisting of Au, Ag, Fe, Co, Ni and Al.

53. The process of claim 50, wherein the positioning comprises positioning nanoparticles that are less than about 20 nm in diameter, less than about 10 nm in diameter or less than about 5 nm in diameter.

54. The process of claim 50, wherein the heating does not melt the substrate.

55. The process of claim 50, further comprising providing a first gas species during heating.

56. The process of claim 55, comprising providing a gas species that lowers the melting temperature of the nanoparticles.

57. The process of claim 56, comprising providing hydrogen.

58. A film on a substrate, prepared by a process comprising:
(a) positioning nanoparticles on a surface of the substrate; and
(b) heating at least the nanoparticles to a temperature where the nanoparticles melt and form the film on the substrate,
wherein the nanoparticles comprise group IV semiconductor material or metal, and
wherein the nanoparticles comprise a surface ligand attached to an outer surface thereof.

59. The film of claim 58, wherein the nanoparticles comprise group IV semiconductor material selected from the group consisting of Si, Ge, Sn, C and Zr.

60. The film of claim 58, wherein the nanoparticles comprise metal selected from the group consisting of Au, Ag, Fe, Co, Ni and Al.

61. The film of claim 58, wherein the nanoparticles are less than about 20 nm in diameter, less than about 10 nm in diameter or less than about 5 nm in diameter.

62. The film of claim 58, wherein the substrate is a flexible, low melting point substrate.

63. The film of claim 58, wherein the film is a silicon film on a flexible polymer substrate.

64. The film of claim 58, wherein the substrate is selected from the group consisting of poly(ethylene terephthalate), poly(phenylene polyimide), poly(propylene), poly(dimethylsiloxane) and poly(etheretherketon).

65. A display comprising a film of claim 58.

66. A radiofrequency identifier tag comprising a film of claim 58.

67. A transistor backplane comprising a film of claim 58.
